(19) United States
(12) Patent Application Publication
(10) Pub. No.: US 2012/0002794 A1
(43) Pub. Date: Jan. 5, 2012

(54) SYSTEM AND METHOD FOR VOICEMAIL TO TEXT CONVERSION

(75) Inventors: Jacqueline JACKSON, Somerset, NJ (US); Michael ZUBAS, Marietta, GA (US)

(73) Assignee: AT&T MOBILITY II LLC., Atlanta, GA (US)

(21) Appl. No.: 12/828,677

(22) Filed: Jul. 1, 2010

(51) Int. Cl. H04M 11/00

(52) U.S. Cl. 379/88.14

(57) ABSTRACT

A voicemail platform which provides a voicemail to text conversion service to a user includes a storage system which stores username data for a user of a voicemail to text conversion service, and a processing system. The processing system receives a voicemail message for the user, sends the voicemail message and the username data to a speech engine, receives text from the speech engine which is converted from the voicemail message using the username data to correctly spell all occurrences of the user's name within the voicemail message, and sends the converted text to a device of the user.

### BACKGROUND

1. Field of the Disclosure

The present disclosure relates to voicemail to text conversion. More particularly, the present disclosure relates to a manner of improving the accuracy of a voicemail to text conversion of a user's name.

2. Background Information

A voicemail to text conversion service is a service which converts a voicemail message to text. Typically, a user's name (i.e., a called party's name) will be mentioned at least once in a voicemail message. However, a name is a difficult word for a speech engine to accurately convert to text. Thus, a user of a voicemail to text conversion service may find his or her name to be constantly misspelled in their converted text messages.

### BRIEF DESCRIPTION OF THE DRAWINGS

FIG. 1 shows an example of a general computer system that includes a set of instructions for voicemail to text conversion described herein;

FIG. 2 shows an example of a system for voicemail to text conversion, according to an aspect of the present disclosure;

FIG. 3 shows an example of an algorithm performed by a voicemail platform, according to an aspect of the present disclosure; and

FIG. 4 shows an example of an algorithm performed by a speech engine, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

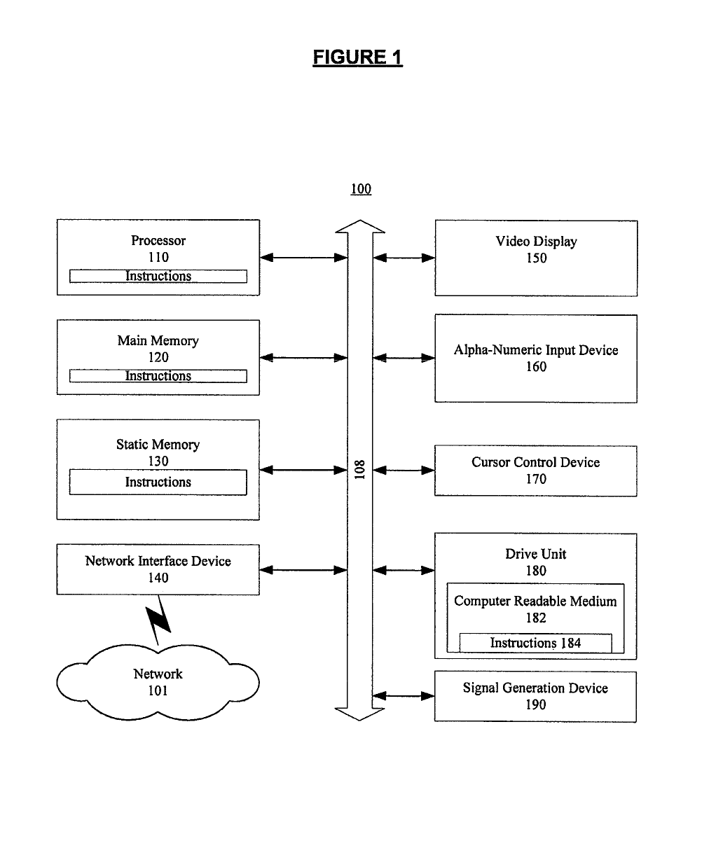

FIG. 1 is an illustrative embodiment of a general computer system that includes a set of instructions for performing processes as described herein. The general computer system is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices. For example, the computer system 100 may include or be included within any one or more of the computers, servers, systems, or communication networks described herein.

In a networked deployment, the computer system may operate in the capacity of a server or as a client user computer in a server-client user network environment, or as a peer computer system in a peer-to-peer (or distributed) network environment. The computer system 100, or portions thereof, can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an alpha-numeric input device 160, such as a keyboard, another input device (not shown), such as a remote control device having a wireless keypad, a keyboard, a microphone coupled to a speech recognition engine, a camera such as a video camera or still camera, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible, non-transitory article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

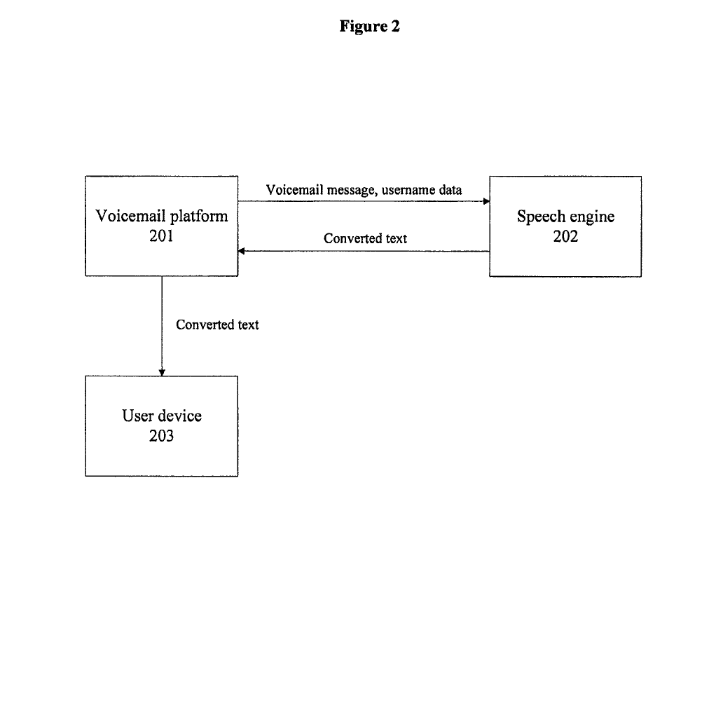

FIG. 2 illustrates an example of a system for voicemail to text conversion. The system may include a voicemail platform 201 and a speech engine 202. The voicemail platform 201 and the speech engine 202 may be independently owned or operated. For example, the voicemail platform 201 may be operated by a wireline or wireless telephone carrier, and the speech engine 202 may be run on a server operated by a third-party vendor. Alternatively, the voicemail platform 201 and the speech engine 202 may be integrated within one system and may both be operated by a carrier.

The voicemail platform 201 receives a voicemail message from a calling party which is directed to a voicemail user (a called party). The voicemail platform 201 may be a centralized computer system which stores incoming voicemail messages in personal mailboxes associated with user phone numbers. The voicemail messages may be stored in a storage system which includes storage media such as, but not limited to, hard disk drives.

The voicemail platform 201 may also store data pertinent to each voicemail user. For example, the voicemail platform 201 may store an email address associated with each voicemail user. For a voicemail user who utilizes a voicemail to text conversion service, the converted text can be delivered to the user in the form of an email message addressed to the email address stored in the voicemail platform 201. The voicemail platform 201 may also store other data pertinent to each voicemail user, such as a user's name.

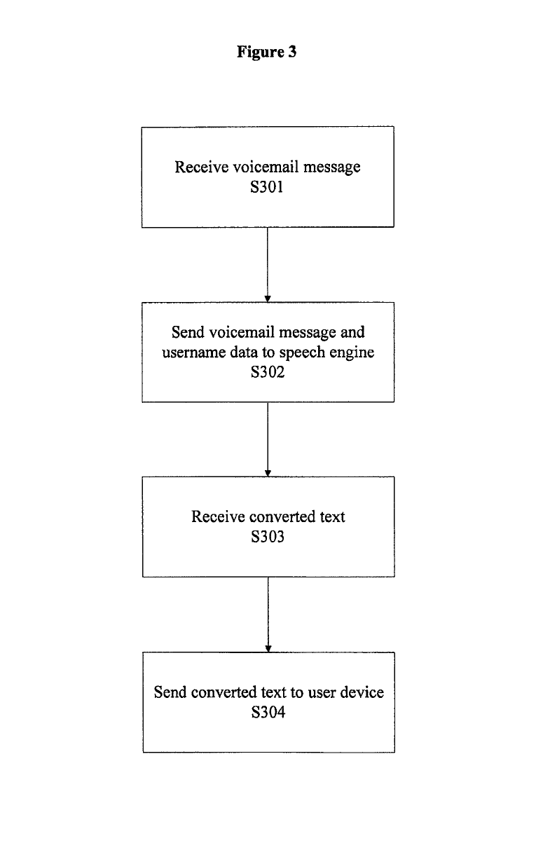

The voicemail platform 201 sends the voicemail, as well as username data of the voicemail user, to the speech engine 202. In this regard, the voicemail platform 201 may include a processing system including one or more processors programmed to perform the algorithm illustrated in FIG. 3. According to the algorithm shown in FIG. 3, after receiving a voicemail for a user of a voicemail to text conversion service (S301), the voicemail platform 201 sends the voicemail and username data of the user to the speech engine 202 (S302). The speech engine 202 converts the voicemail to text, using the username data to correctly spell all instances of the user's name within the voicemail.

The speech engine 202 determines the correct spelling of the user's name from the username data. The username data may be an email address of the user. In this regard, a user's email address typically contains all or part of a user's name. For example, a person named ‘Rick Jones’ who is an employee of XYZ corporation may have an email address of ‘rick.jones@xyz.com’. The speech engine 202 may be capable of parsing the email address and extracting the correct spelling of the user's name from the email address.

Alternatively, the voicemail platform 201 may parse the user's email address and extract the correct spelling of the user's name from the email address, and then send the correct spelling of the user's name to the speech engine 202 as the username data.

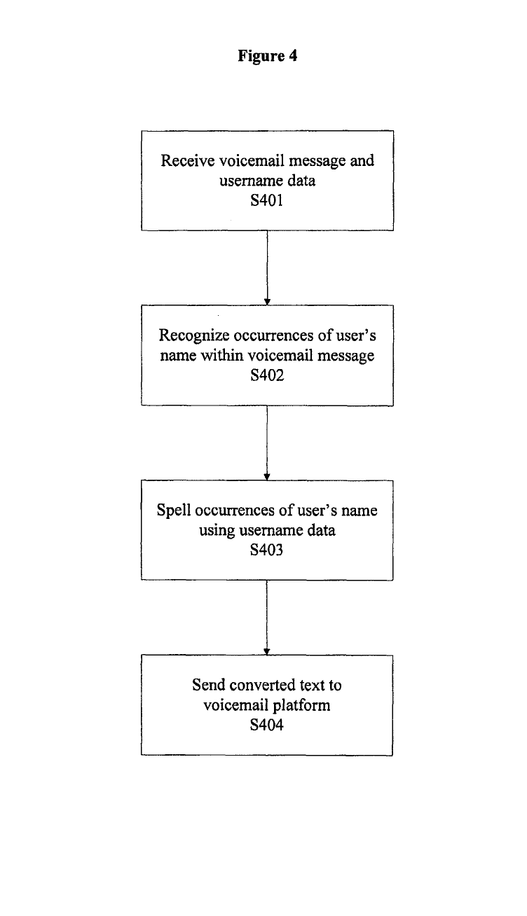

The speech engine 202 performs a voicemail to text conversion algorithm to convert the voicemail to text. In this regard, the speech engine 202 may include a processing system including one or more processors programmed to perform the algorithm illustrated in FIG. 4. According to the algorithm shown in FIG. 4, the speech engine 202 receives the voicemail message and username data from the voicemail platform 201 (S401), and converts the voicemail message to text. During the conversion, the speech engine 202 recognizes every occurrence of the user's name within the voicemail message (S402), and uses the username data to correctly spell each corresponding occurrence of the user's name within the converted text (S403). The speech engine 202 may recognize the user's name, for example, by comparing phones within the voicemail message to a predetermined phone stored in the speech engine corresponding to the user's name. After the voicemail to text conversion algorithm is performed, the speech engine 202 sends the converted text to the voicemail platform 201 (S404).

The voicemail platform 201 then receives the converted text from the speech engine 202 (S303), and delivers the converted text to a device 203 of the user, such as, but not limited to, a phone, a PDA, a tablet device or a PC (S304). The converted text may be delivered to the voicemail user in a variety of formats, such as, but not limited to, an email or a Short Message Service (SMS) text message.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

According to an aspect of the present disclosure, a voicemail platform which provides a voicemail to text conversion service to a user includes a storage system which stores username data for a user of a voicemail to text conversion service, and a processing system. The processing system receives a voicemail message for the user, sends the voicemail message and the username data to a speech engine, receives text from the speech engine which is converted from the voicemail message using the username data to correctly spell all occurrences of the user's name within the voicemail message, and sends the converted text to a device of the user.

The converted text may be delivered to the device of the user in the form of an email message. The username data may be an email address of the user. The email address may contain at least part of the user's name.

The voicemail platform may determine the username data from an email address of the user. The device of the user may be a phone, a PDA, a tablet device or a PC. The voicemail platform may be operated by a telephone carrier, and the speech engine may be operated by a third-party vendor.

According to another aspect of the present disclosure, a method for providing a voicemail to text conversion service to a user includes storing username data for a user of a voicemail to text conversion service in a storage system of a voicemail platform, receiving a voicemail message for the user at the voicemail platform, sending the voicemail message and the username data from the voicemail platform to a speech engine, receiving text at the voicemail platform from the speech engine which is converted from the voicemail message using the username data to correctly spell all occurrences of the user's name within the voicemail message, and sending the converted text from the voicemail platform to a device of the user.

According to another aspect of the present disclosure, a non-transitory computer-readable medium storing a program for providing a voicemail to text conversion service to a user includes code for storing username data for a user of a voicemail to text conversion service in a storage system of a voicemail platform, code for receiving a voicemail message for the user at the voicemail platform, code for sending the voicemail message and the username data from the voicemail platform to a speech engine, code for receiving text at the voicemail platform from the speech engine which is converted from the voicemail message using the username data to correctly spell all occurrences of the user's name within the voicemail message, and code for sending the converted text from the voicemail platform to a device of the user.

While a computer-readable medium herein may be shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for power over ethernet represent an example of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A voicemail platform which provides a voicemail to text conversion service to a user, comprising:
a storage system which stores username data for a user of a voicemail to text conversion service; and
a processing system which:
receives a voicemail message for the user,
sends the voicemail message and the username data to a speech engine,
receives text from the speech engine which is converted from the voicemail message using the username data to correctly spell all occurrences of the user's name within the voicemail message, and
sends the converted text to a device of the user.

2. A voicemail platform according to claim 1, wherein the converted text is delivered to the device of the user in the form of an email message.

3. A voicemail platform according to claim 1, wherein the username data is an email address of the user.

4. A voicemail platform according to claim 3, wherein the email address contains at least part of the user's name.

5. A voicemail platform according to claim 1, wherein the voicemail platform determines the username data from an email address of the user.

6. A voicemail platform according to claim 1, wherein the device of the user is one of a phone, a personal digital assistant, a tablet device and a personal computer.

7. A voicemail platform according to claim 1, wherein the voicemail platform is operated by a telephone carrier, and the speech engine is operated by a third-party vendor.

8. A method for providing a voicemail to text conversion service to a user, comprising:
storing username data for a user of a voicemail to text conversion service in a storage system of a voicemail platform;
receiving a voicemail message for the user at the voicemail platform;
sending the voicemail message and the username data from the voicemail platform to a speech engine;
receiving text at the voicemail platform from the speech engine which is converted from the voicemail message using the username data to correctly spell all occurrences of the user's name within the voicemail message; and
sending the converted text from the voicemail platform to a device of the user.

9. A method according to claim 8, wherein the converted text is delivered to the device of the user in the form of an email message.

10. A method according to claim 8, wherein the username data is an email address of the user.

11. A method according to claim 10, wherein the email address contains at least part of the user's name.

12. A method according to claim 8, wherein the voicemail platform determines the username data from an email address of the user.

13. A method according to claim 8, wherein the device of the user is a phone, a personal digital assistant, a tablet device and a personal computer.

14. A method according to claim 8, wherein the voicemail platform is operated by a telephone carrier, and the speech engine is operated by a third-party vendor.

15. A non-transitory computer-readable medium storing a program for providing a voicemail to text conversion service to a user, the medium comprising:
code for storing username data for a user of a voicemail to text conversion service in a storage system of a voicemail platform;
code for receiving a voicemail message for the user at the voicemail platform;
code for sending the voicemail message and the username data from the voicemail platform to a speech engine;
code for receiving text at the voicemail platform from the speech engine which is converted from the voicemail message using the username data to correctly spell all occurrences of the user's name within the voicemail message; and
code for sending the converted text from the voicemail platform to a device of the user.

16. A computer-readable medium according to claim 15, wherein the converted text is delivered to the device of the user in the form of an email message.

17. A computer-readable medium according to claim 15, wherein the username data is an email address of the user.

18. A computer-readable medium according to claim 17, wherein the email address contains at least part of the user's name.

19. A computer-readable medium according to claim 15, wherein the voicemail platform determines the username data from an email address of the user.

20. A computer-readable medium according to claim 15, wherein the device of the user is a phone, a personal digital assistant, a tablet device and a personal computer.
